(19) United States
(12) Patent Application Publication
(10) Pub. No.: US 2011/0267377 A1
(43) Pub. Date: Nov. 3, 2011

(54) LIQUID CRYSTAL DISPLAY, AND AN APPARATUS AND A METHOD FOR DRIVING THE SAME

(75) Inventors: Hun Bae KIM, Yongin-city (KR); Young Seob Kim, Yongin-city (KR)

(73) Assignee: Samsung Mobile Display Co., Ltd., Yongin-City (KR)

(21) Appl. No.: 13/014,125

(22) Filed: Jan. 26, 2011

(30) Foreign Application Priority Data
Apr. 28, 2010 (KR) 10-2010-0039495

(51) Int. Cl. G09G 5/10; G09G 3/36

(52) U.S. Cl. 345/690; 345/102

(57) ABSTRACT

A method of driving a liquid crystal display (LCD) that operates by receiving power from a battery includes generating a pulse width modulation (PWM) signal for adjusting brightness of a backlight unit of the LCD; detecting a battery voltage of the battery; and adjusting the PWM signal according to the detected battery voltage.

### CROSS-REFERENCE TO RELATED APPLICATION

This application claims the benefit of Korean Patent Application No. 10-2010-0039495, filed Apr. 28, 2010 in the Korean Intellectual Property Office, the disclosure of which is incorporated herein by reference.

### BACKGROUND

1. Field

Aspects of the present invention relates to a liquid crystal display (LCD), and an apparatus and method of driving the LCD.

2. Description of the Related Art

A liquid crystal display (LCD) displays an image corresponding to input data via a data driving unit that converts the input data into a data voltage, and a gate driving unit that adjusts a brightness of each pixel by controlling a scanning operation of each pixel. The LCD may adjust the brightness of a backlight unit so as to adjust brightness of the image displayed on the LCD.

### SUMMARY

Aspects of the present invention provide a liquid crystal display (LCD), and an apparatus and method of driving the LCD, whereby screen flicker occurring during a fading function is prevented when brightness of a backlight unit is adjusted by performing a PWM method.

According to an aspect of the present invention, there is provided a method of driving a liquid crystal display (LCD) that operates by receiving power from a battery, the method including the operations of generating a pulse width modulation (PWM) signal for adjusting brightness of a backlight unit; detecting a battery voltage; and adjusting the PWM signal according to the battery voltage.

According to an aspect of the present invention, the operation of adjusting the PWM signal may include the operations of comparing the battery voltage with a reference voltage; setting a frequency of the PWM signal as a first frequency when the battery voltage is larger than the reference voltage; and setting the frequency of the PWM signal as a second frequency when the battery voltage is equal to or less than the reference voltage, wherein the first frequency is larger than the second frequency.

According to an aspect of the present invention, the operation of adjusting the PWM signal may include the operations of comparing the battery voltage with a reference voltage; setting a frequency of the PWM signal as a first frequency when the battery voltage is larger than the reference voltage; and disabling the PWM signal so as to disable the adjusting of the brightness of the backlight unit by the PWM signal, when the battery voltage is equal to or less than the reference voltage.

According to an aspect of the invention, when the battery voltage is equal to or less than the reference voltage, the method may further include the operation of controlling the brightness of the backlight unit by directly controlling an amplitude of a driving current that is supplied to the backlight unit.

According to an aspect of the invention, the first frequency may be a frequency for preventing a stripe noise from occurring on a display screen of the LCD, and the second frequency may be a frequency for preventing screen flicker from occurring on the LCD when the brightness of the backlight unit is adjusted by performing a fading method.

According to an aspect of the invention, the method may further include the operations of adjusting the brightness of the backlight unit according to an input image of the LCD; and disabling the adjusting of the brightness of the backlight unit according to the input image, when the battery voltage is equal to or less than a reference voltage.

According to an aspect of the invention, the method may further include the operation of determining whether the adjusting of the brightness of the backlight unit is performed by using a fading method, and the operation of detecting the battery voltage and the operation of adjusting the PWM signal may be performed only when the adjusting of the brightness of the backlight unit is performed by using the fading method.

According to an aspect of the invention, the method may further include the operation of determining whether an event for changing the brightness of the backlight unit occurs, and the operation of detecting the battery voltage and the operation of adjusting the PWM signal may be performed only when the event for changing the brightness of the backlight unit occurs.

According to an aspect of the invention, the backlight unit may include a light emitting diode (LED).

According to another aspect of the present invention, there is provided an apparatus for driving an LCD that operates by receiving power from a battery and includes a backlight unit, the apparatus including a battery voltage detecting unit for detecting a battery voltage; and a PWM signal generating unit for generating a PWM signal so as to control brightness of the backlight unit, and for adjusting the PWM signal according to the battery voltage.

According to an aspect of the invention, the battery voltage detecting unit may compare the battery voltage with a reference voltage, and then may output a battery voltage detection signal to the PWM signal generating unit, wherein the battery voltage detection signal indicates a result of the comparison; the PWM signal generating unit may set a frequency of the PWM signal as a first frequency when the battery voltage is larger than the reference voltage, and may set the frequency of the PWM signal as a second frequency when the battery voltage is equal to or less than the reference voltage; and the first frequency may be larger than the second frequency.

According to an aspect of the invention, the battery voltage detecting unit may compare the battery voltage with a reference voltage, and then may output a battery voltage detection signal to the PWM signal generating unit, wherein the battery voltage detection signal indicates a result of the comparison; and when the battery voltage is larger than the reference voltage, the PWM signal generating unit may set a frequency of the PWM signal as a first frequency, and when the battery voltage is equal to or less than the reference voltage, the PWM signal generating unit may disable the PWM signal so as to disable adjustment of the brightness of the backlight unit by the PWM signal. Also, when the battery voltage is equal to or less than the reference voltage, the PWM signal generating unit may generate a PWM disable control signal for controlling the brightness of the backlight unit by directly controlling an amplitude of a driving current that is supplied to the backlight unit.

According to an aspect of the invention, the apparatus may further include a backlight driving unit for generating a backlight driving signal, outputting the backlight driving signal to the backlight unit, and adjusting the brightness of the backlight unit by adjusting an amplitude of a current of the backlight driving signal, the PWM signal generating unit may output the PWM signal to the backlight driving unit, and the backlight driving unit may include a PWM control unit for generating the backlight driving signal according to the PWM signal, outputting the backlight driving signal to the backlight unit, and operating only when the PWM disable control signal is disabled; and a current adjustment control unit for generating the backlight driving signal by directly controlling the amplitude of the current of the backlight driving signal so as to adjust the brightness of the backlight unit, and operating only when the PWM disable control signal is enabled.

According to an aspect of the invention, the apparatus may further include a brightness determining unit for adjusting the brightness of the backlight unit according to an input image of the LCD, and when the battery voltage is less than the reference voltage, the brightness determining unit may disable adjustment of the brightness of the backlight unit according to the input image.

According to an aspect of the invention, the apparatus may further include a fading control unit for controlling the brightness of the backlight unit to be adjusted by using a fading method, and the PWM signal generating unit may adjust the PWM signal according to the battery voltage only when the adjustment of the brightness of the backlight unit is performed by using the fading method.

According to an aspect of the invention, the PWM signal generating unit may adjust the PWM signal according to the battery voltage only when an event for changing the brightness of the backlight unit occurs.

According to another aspect of the present invention, there is provided an LCD including a plurality of pixels positioned at crossing points of data lines and gate lines; a gate driving unit for outputting a scan pulse to each of the plurality of pixels via the gate lines; a data driving unit for generating a data voltage corresponding to an input image, and then outputting the data voltage to each of the plurality of pixels via the data lines; a backlight unit for emitting light to the plurality of pixels; a backlight driving unit for controlling an operation of the backlight unit; and a brightness adjusting unit for outputting a pulse width modulation (PWM) signal to the backlight driving unit, wherein the brightness adjusting unit includes a battery voltage detecting unit for detecting a battery voltage; and a PWM signal generating unit for generating a PWM signal so as to control brightness of the backlight unit, and for adjusting the PWM signal according to the battery voltage.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a diagram of a structure of a liquid crystal display (LCD) according to an embodiment of the present invention;

FIG. 2 is a diagram of a configuration of a pixel according to another embodiment of the present invention;

FIG. 3 is a graph for illustrating an example of a fading method;

FIG. 4 is a diagram of structures of a brightness adjusting unit and a backlight driving unit according to another embodiment of the present invention;

FIG. 5 is a flowchart of a method of driving an LCD, according to an embodiment of the present invention;

FIG. 6 is a diagram of a structure of a brightness adjusting unit and a backlight driving unit according to another embodiment of the present invention;

FIG. 7 is a flowchart of a method of driving an LCD, according to another embodiment of the present invention;

FIG. 8 is a diagram of structure of a brightness adjusting unit and a backlight driving unit according to another embodiment of the present invention; and

FIG. 9 is a flowchart of a method of driving an LCD, according to another embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The following description and drawings are provided to give a sufficient understanding of embodiments of the present invention, and functions or constructions that are well-known to one of ordinary skill in the art may be omitted. Throughout the specification, it will also be understood that when an element is referred to as being “connected to” or “coupled with” another element, it can be directly on the other element, or intervening elements may also be present. However, when an element is referred to as being “directly connected to” or “directly coupled with” another element, it will be understood that there are no intervening elements. Like reference numerals denote like elements. Throughout the specification, a term “and/or” includes at least one from among all listed components and one or more combinations of all listed components.

While terms “first” and “second” are used to describe various components, parts, regions, layers and/or portions, it is obvious that the components, parts, regions, layers and/or portions are not limited to the terms “first” and “second”. The terms “first” and “second” are used only to distinguish between each of components, each of parts, each of regions, each of layers and/or each of portions. Thus, throughout the specification, a first component, a first part, a first region, a first layer or a first portion may indicate a second component, a second part, a second region, a second layer or a second portion without conflicting with the inventive concept.

Throughout the specification, a singular form may include plural forms, unless there is a particular description contrary thereto. Also, terms such as “comprise” or “comprising” are used to specify existence of a recited form, a number, a process, an operations, a component, and/or groups thereof, not excluding the existence of one or more other recited forms, one or more other numbers, one or more other processes, one or more other operations, one or more other components and/or groups thereof.

Unless expressly described otherwise, all terms including descriptive or technical terms which are used herein should be construed as having meanings that are obvious to one of ordinary skill in the art. Also, terms that are defined in a general dictionary and that are used in the following description should be construed as having meanings that are equivalent to meanings used in the related description, and unless expressly described otherwise herein, the terms should not be construed as being ideal or excessively formal.

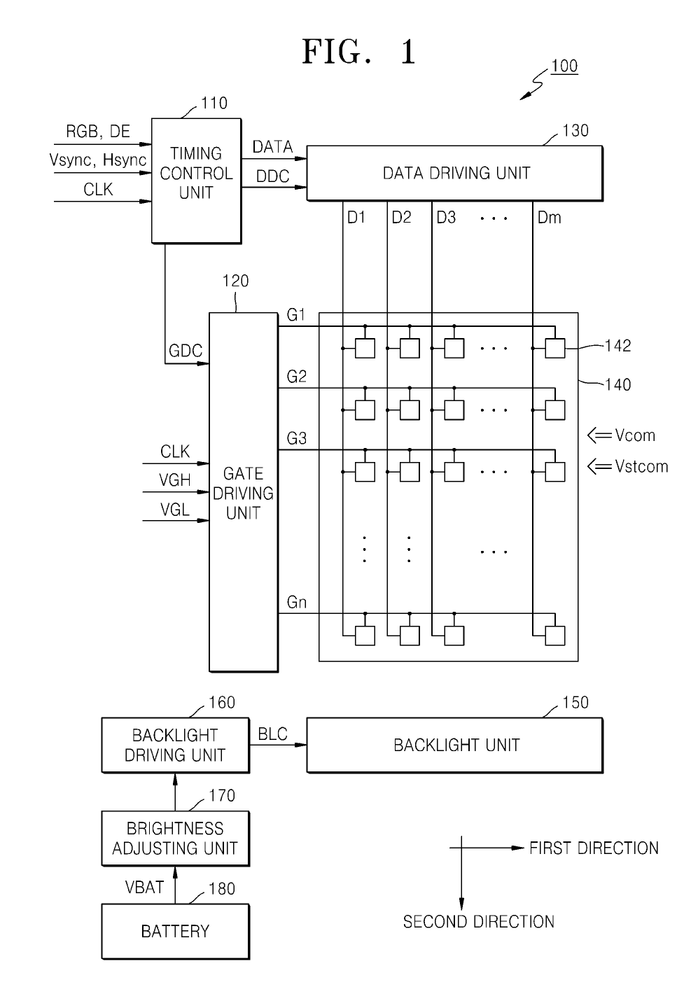

FIG. 1 is a diagram of a structure of a liquid crystal display (LCD) 100 according to an embodiment of the present invention. The LCD 100 includes a timing control unit 110, a gate driving unit 120, a data driving unit 130, a pixel unit 140, a backlight unit 150, a backlight driving unit 160, a brightness adjusting unit 170, and a battery 180.

The timing control unit 110 receives an input image signal RGB, a data enable signal DE, a vertical synchronization signal Vsync, a horizontal synchronization signal Hsync, and a clock signal CLK from an external graphic controller (not shown), and then generates an image data signal DATA, a data driving control signal DDC, and a gate driving control signal GDC. The timing control unit 110 receives input control signals including the horizontal synchronization signal Hsync, the clock signal CLK, and the data enable signal DE, and then outputs the data driving control signal DDC from these signals. Here, the data driving control signal DDC functions to control an operation of the data driving unit 130, and includes a source shift clock SSC, a source start pulse SSP, a polarity control signal POL, a source output enable signal SOE, or the like. The timing control unit 110 receives the vertical synchronization signal Vsync and the clock signal CLK, and then outputs the gate driving control signal GDC from these signals. The gate driving control signal GDC functions to control an operation of the gate driving unit 120, and includes a gate start pulse GSP, a gate output enable signal GOE, or the like.

The gate driving unit 120 sequentially generates a scan pulse (that is, a gate pulse), in correspondence to the gate driving control signal GDC supplied from the timing control unit 110, and supplies the scan pulse to gate lines G1 through Gn. Here, the gate driving unit 120 decides a voltage level of the scan pulse according to each of a gate high voltage VGH and a gate low voltage VGL. The voltage level of the scan pulse may vary according to types of a switching device included in each pixel 142. That is, in a case where the switching device M1 is formed as an n-type transistor, the scan pulse has the gate high voltage VGH during a scan pulse activation period. In a case where the switching device is formed as a p-type transistor, the scan pulse has the gate low voltage VGL during a scan pulse activation period.

The data driving unit 130 supplies a data voltage to data lines D1 through DM, wherein the data voltage corresponds to the image data signal DATA and the data driving control signal DDC, which are supplied from the timing control unit 110. In more detail, the data driving unit 130 latches the image data signal DATA by sampling the image data signal DATA supplied from the timing control unit 110, and then converts the image data signal DATA into an analogue data voltage capable of expressing a gray scale in the pixels 142 of the pixel unit 140 according to a gamma reference voltage that is supplied from a gamma reference voltage circuit (not shown).

The pixel unit 140 includes the pixels 142 positioned near crossing points of the data lines D1 through DM and the gate lines G1 through Gn. Each of the pixels 142 is connected to at least one data line Di and at least one gate line Gj. The gate lines G1 through Gn are parallel to each other in a first direction, and the data lines D1 through DM are parallel to each other in a second direction. Obviously, the gate lines G1 through Gn may be disposed in parallel in the second direction, and the data lines D1 through DM may be disposed in parallel in the first direction. In addition, a common voltage Vcom and a storage power voltage Vstcom may be supplied to each of the pixels 142.

The backlight unit 150 is disposed at a rear side of the pixel unit 140, emits light according to a backlight driving signal BLC that is supplied from the backlight driving unit 160. The light is emitted toward the pixels 142 of the pixel unit 140. The backlight unit 150 may include at least one of a cold cathode fluorescent lamp (CCFL), an external electrode fluorescent lamp (EEFL), a flat fluorescent lamp (FFL), a light emitting diode (LED), and the like.

The backlight driving unit 160 outputs the backlight driving signal BLC to the backlight unit 150, and thus adjusts the ON/OFF control and brightness of the backlight unit 150. For example, the backlight driving signal BLC may be a driving signal for controlling the brightness of the backlight unit 150 according to an amplitude of a current.

The brightness adjusting unit 170 adjusts the brightness of an image displayed on the LCD 100, and for the adjustment, the brightness adjusting unit 170 outputs a control signal for brightness adjustment to the backlight driving unit 160. According to the present embodiment, the control signal for brightness adjustment is a pulse width modulation (PWM) signal, and the brightness adjusting unit 170 may adjust the brightness of the backlight unit 150 by performing a PWM method. The PWM method involves adjusting the brightness of the backlight unit 150 by adjusting a duty ratio of pulses that are included in the PWM signal. As the duty ratio increases, the brightness of the backlight unit 150 may be increased, and as the duty ratio decreases, the brightness of the backlight unit 150 may be decreased. Also, according to the present embodiment, the brightness adjusting unit 170 may adjust brightness via a contents-based brightness control (CABC), a battery voltage-based brightness control (VABC), and/or an external light-based brightness control (LABC).

The battery 180 supplies power to the LCD 100, and may be detachable. In order to detect the amount of remaining power of the battery 180, the brightness adjusting unit 170 may detect a voltage level of the battery 180, that is, a battery voltage VBAT. However, the power source is not specifically limited to the battery 180, and can be supplied from external sources and/or other types of power storage devices or power generation devices such as fuel cells.

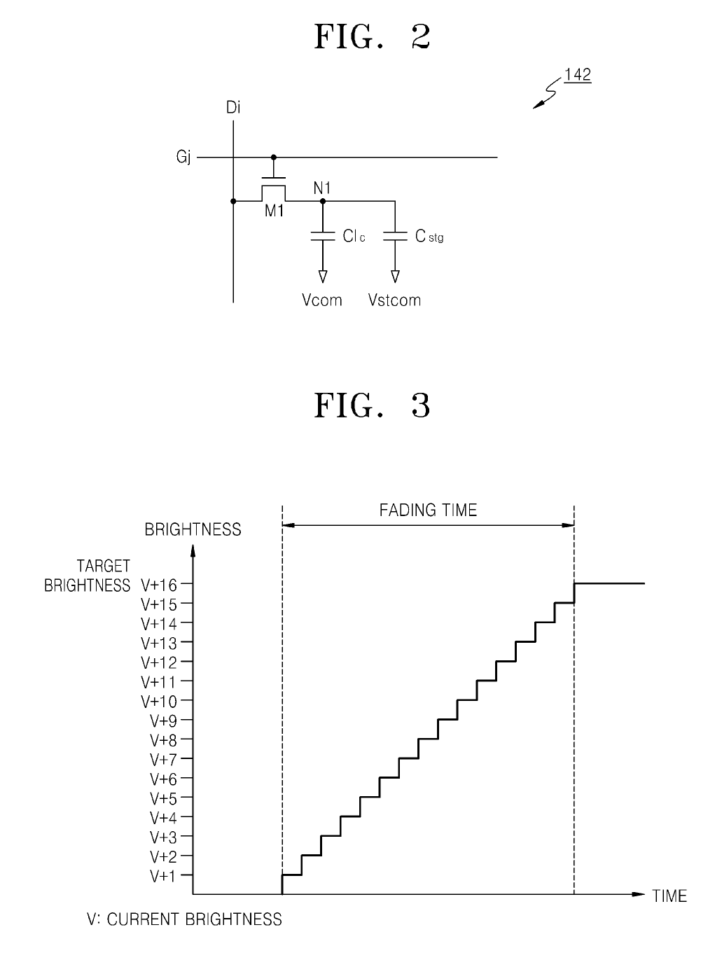

FIG. 2 is a diagram of a configuration of one of the pixels 142 according to an embodiment of the present invention. The pixel 142 includes a switching device M1, a liquid crystal capacitor Clc, and a storage capacitor Cstg. Here, the pixel 142 includes upper/lower substrates (in particular, common electrodes and pixel electrodes formed on the upper/lower substrates) of an LCD panel, and the liquid crystal capacitor Clc including a liquid crystal layer interposed between the upper and lower substrates. The switching device M1 includes a gate electrode connected to a gate line Gj, a first electrode connected to a data line Di, and a second electrode connected to a first node N1. The switching device M1 may be formed as a thin film transistor (TFT). The first node N1 is electrically equivalent to a pixel electrode. The liquid crystal capacitor Clc is connected between the first node N1 and the common voltage Vcom. The common voltage Vcom may be supplied via a common electrode. The liquid crystal capacitor Clc is equivalently represented by the pixel electrode, the common electrode, and the liquid crystal layer interposed between the pixel electrode and the common electrode. The storage capacitor Cstg is connected between the first node N1 and the storage power voltage Vstcom.

When a scan pulse is input to the gate line Gj, the switching device M1 is turned on so that a data voltage that is input via the data line Di is applied to the first node N1. Then, a voltage level corresponding to the data voltage is stored in the storage capacitor Cstg. Orientation of the liquid crystal layer is changed according to a voltage of the first node N1 so that light transmittance of the liquid crystal layer is changed.

As described above, the LCD 100 may adjust the brightness of the backlight unit 150 by performing a PWM method. The PWM method may involve maintaining a frequency of a PWM signal at a level equal to or higher than a reference level, and thus may prevent a stripe noise (i.e., a waterfall noise) that may occur while the LCD 100 is driven. Due to this advantage, the PWM method is widely used to control the brightness of the backlight unit 150. The PWM method involves controlling brightness according to a duty ratio. A duty value of the PWM signal may not be segmented to be larger than a reference step. For example, the duty value of the PWM signal may not be segmented to be larger than 256 steps.

Meanwhile, when adjusting the brightness of the backlight unit 150, in order to make a user not detect a brightness change, a fading method is widely used, in which the brightness of the backlight unit 150 is slowly increased or decreased. The fading method involves adjusting brightness by passing through a plurality of steps between current brightness and target brightness, or adjusting brightness during a predetermined time period. FIG. 3 is a graph illustrating an example of the fading method. As illustrated in FIG. 3, in a case where brightness is adjusted by performing the fading method, the brightness may be adjusted during a predetermined fading time period by passing through N steps (16 steps in the example of FIG. 3) between current brightness and target brightness. Also, each step may correspond to one frame. That is, in a case where the brightness is adjusted by passing through 16 steps, the brightness may be adjusted over 16 frames. A fading time of a case in which the brightness is adjusted by using the PWM method is limited to a time according to a change of a frequency. Also, in a case of the duty value of the PWM signal, the duty value may not be segmented to be larger than the reference step due to limitation in accuracy of a signal input with respect to each step. For example, the duty value may not be segmented to be larger than 256 steps. For example, in a case where a PWM frequency is 100 Hz, the fading time may not exceed 0.72 seconds, in a case where the PWM frequency is 60 Hz, the fading time may not exceed 1.2 seconds, and a variation value of the brightness in the fading time may not be segmented to be larger than segmentation of the PWM signal.

In a case where a fading operation is performed in the LCD 100 in which the brightness of the backlight unit 150 is adjusted by performing the fading method, if a difference between the current brightness and the target brightness is relatively small, screen flicker occurs when the fading operation is performed. In this regard, a case in which a frequency of a PWM signal is 100 Hz, the number of PWM steps is 256 steps, a fading time is 0.72 seconds, and the number of fading steps is 16 steps will now be described. In the case, the backlight driving unit 160 controls an amplitude of a current of the backlight driving signal BLC, and controls the brightness of the backlight unit 150. In a first driving example, when the amplitude of the current of the backlight driving signal BLC at the current brightness is 15 mA, and the amplitude of the current of the backlight driving signal BLC at the target brightness is 2 mA, a PWM duty value variation of 111 steps occurs during 16 fading steps. Here, the fading operation is performed while the amplitude of the current of the backlight driving signal BLC varies by about 1 mA in each of the 16 fading steps. In a second driving example, when the amplitude of the current of the backlight driving signal BLC at the current brightness is 5 mA, and the amplitude of the current of the backlight driving signal BLC at the target brightness is 2 mA, a PWM duty value variation of 25 steps occurs during 16 fading steps. Here, the fading operation is performed while the amplitude of the current of the backlight driving signal BLC varies by about 0.3 mA in each of the 16 fading steps. However, in the case of the second driving example, the amplitude of the current varying in each step is too small, such that screen flicker may occur in each step. As described above, since the fading time is limited to be equal to or less than a predetermined time, it is impossible to extend the fading time so as to eliminate the screen flicker. The screen flicker may look worse due to a ripple at a power unit, which occurs since a power efficiency deteriorates when a charge pumping mode of the backlight driving unit 160 is changed from 1x mode to 1.33x mode.

The screen flicker in the fading operation causes a problem when the battery voltage VBAT is low. When the battery voltage VBAT is low, the LCD 100 decreases a range of the current of the backlight driving signal BLC so as to decrease power consumption. Thus, when the battery voltage VBAT is low, the current of the backlight driving signal BLC flows between very small values (e.g., between 2 mA and 5 mA). In this case, although the backlight unit 150 is changed from a dimming mode to a full current mode, the variation of the current of the backlight driving signal BLC is 3 mA, that is, relatively small, and if the fading operation is performed with respect to the variation of 3 mA during the 16 fading steps, the screen flicker occurs.

However, according to the embodiments of the present invention, the frequency of the PWM signal is adjusted or a PWM control is turned off in conjunction with the battery voltage VBAT, so that a screen flicker problem is solved when the fading operation is performed in the LCD 100.

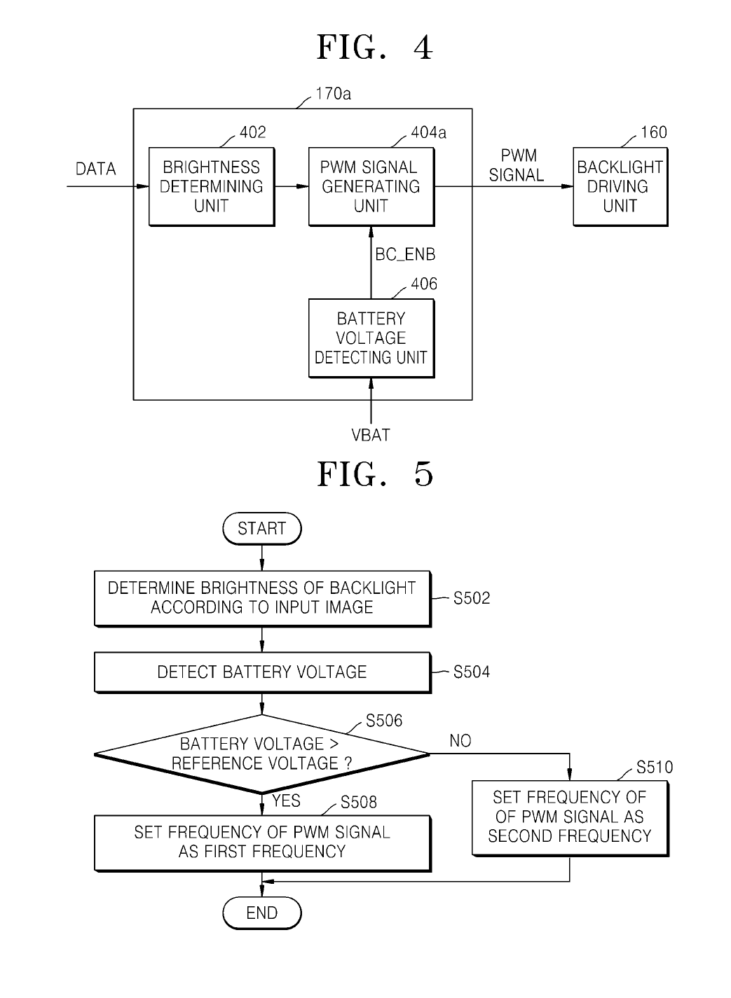

FIG. 4 is a diagram of structures of a brightness adjusting unit 170a and the backlight driving unit 160 according to an embodiment of the present invention. In order to adjust brightness of the LCD 100, the brightness adjusting unit 170a generates a PWM signal and outputs the PWM signal to the backlight driving unit 160. The shown brightness adjusting unit 170a includes a brightness determining unit 402, a PWM signal generating unit 404a, and a battery voltage detecting unit 406, although the invention is not limited thereto.

The brightness determining unit 402 may determine brightness of the backlight unit 150 in various manners. According to the present embodiment, the brightness determining unit 402 may determine the brightness of the backlight unit 150 according to an input image detected in the image data signal DATA. For example, if brightness of the input image is low, the brightness of the backlight unit 150 may be decreased. If the brightness of the input image is high, the brightness of the backlight unit 150 may be increased. However, the brightness determination by the brightness determining unit 402 may not be limited in the brightness determination according to the input image and may vary.

The battery voltage detecting unit 406 detects the battery voltage VBAT from the battery 180. According to the present embodiment, the battery voltage detecting unit 406 may detect whether the battery voltage VBAT is larger than a reference voltage Vref by comparing the battery voltage VBAT with the reference voltage Vref, and may output a battery voltage detection signal BC_ENB to the PWM signal generating unit 404a. The battery voltage detection signal BC_ENB indicates whether the battery voltage VBAT is larger than the reference voltage Vref. The battery voltage detecting unit 406 may be formed of hardware, software, or a combination thereof to function as a comparator. For example, the battery voltage detecting unit 406 may be formed by using an operation amplifier OP-AMP, a transistor, or the like.

The PWM signal generating unit 404a generates the PWM signal according to target brightness determined by the brightness determining unit 402. Here, the PWM signal generating unit 404a determines a duty ratio of the PWM signal according to the target brightness. In a case where a fading operation is performed in the LCD 100, as described above, the PWM signal generating unit 404a slowly increases a duty value of the PWM signal by passing through predetermined steps. When the battery voltage VBAT is equal to or larger than the reference voltage Vref, the PWM signal generating unit 404a may set a frequency of the PWM signal as a first frequency, and when the battery voltage VBAT is less than the reference voltage Vref, the PWM signal generating unit 404a may decrease the frequency of the PWM signal to a second frequency. When the frequency of the PWM signal is decreased, a fading time is extended so that screen flicker at the fading operation may be prevented. For example, the reference voltage Vref may be 3.4V, the first frequency may be 20 Khz, and the second frequency may be 100 hz. The first frequency (20 Khz) may be such so as not to generate a stripe noise in the LCD 100, and the second frequency (100 hz) may be such so as not to cause the screen flicker when the brightness of the backlight unit 150 is adjusted.

The reason why the screen flicker occurs when a battery voltage is equal to or less than 3.4V is that alternating current (AC) coupling occurs in the backlight unit 150 when a charge pump of the backlight driving unit 160 enters 1.xx mode. In a condition where the frequency of the PWM signal is 20 Khz, an edge of the PWM signal may be overlapped with an output change time to 1.xx mode during a fading time of 0.72 seconds in the fading operation, the screen flicker may intermittently occur. When the frequency of the PWM signal is decreased to about 100 Hz, it is possible to see that the screen flicker does not occur. In this regard, if the frequency of the PWM signal is always a low frequency, the screen flicker may not occur but a stripe noise may occur on a screen of the LCD 100. However, if an amplitude of a current of the backlight driving signal BLC is equal to or less than 5 mA, it is possible to see that the stripe noise does not occur on the screen of the LCD 100. Further, when the battery voltage VBAT is low, since the current of the backlight driving signal BLC is generally decreased, the stripe noise is not seen although the frequency of the PWM signal is decreased. Thus, according to the present embodiment, when the battery voltage VBAT is larger than the reference voltage Vref, the frequency of the PWM signal is set as a first frequency, and when the battery voltage VBAT is equal to or less than the reference voltage Vref, the frequency of the PWM signal is set as a second frequency that is less than the first frequency. By doing so, it is possible to solve the screen flicker problem during the fading operation while preventing the occurrence of the stripe noise.

The backlight driving unit 160 receives the PWM signal generated in the PWM signal generating unit 404a, and then generates the backlight driving signal BLC. The amplitude of the current of the backlight driving signal BLC may be increased as a duty ratio of the PWM signal is increased.

FIG. 5 is a flowchart of a method of driving an LCD, according to an embodiment of the present invention. The brightness of the backlight unit 150 is determined according to an input image (operation S502). Also, the battery voltage VBAT is detected (operation S504). The battery voltage VBAT is compared with the reference voltage Vref (operation S506). When the battery voltage VBAT is larger than the reference voltage Vref (operation S506), a frequency of a PWM signal is set as a first frequency (operation S508). When the battery voltage VBAT is equal to or less than the reference voltage Vref (operation S506), the frequency of the PWM signal is set as a second frequency that is less than the first frequency (operation S510).

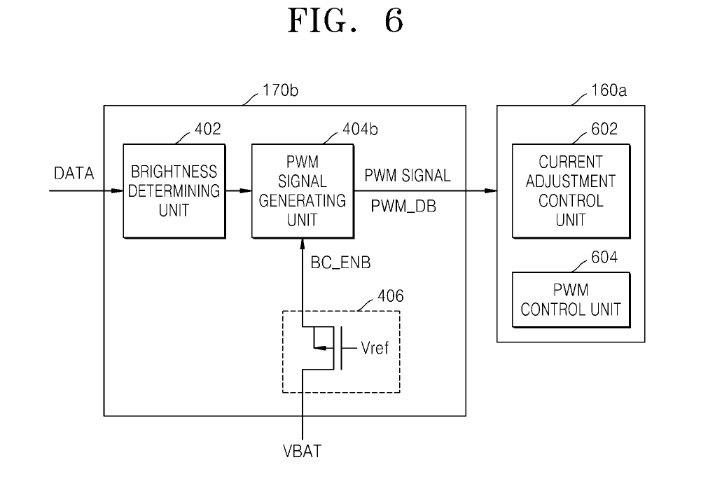

FIG. 6 is a diagram of a structure of a brightness adjusting unit 170b and a backlight driving unit 160a according to another embodiment of the present invention. According to the shown embodiment, when the battery voltage VBAT is larger than the reference voltage Vref, the brightness of the backlight unit 150 is controlled by performing a PWM method. When the battery voltage VBAT is equal to or less than the reference voltage Vref, a brightness control function using the PWM method is stopped. Thus, when the battery voltage VBAT is larger than the reference voltage Vref, a PWM signal generating unit 404b according to the present embodiment outputs a PWM signal to the backlight driving unit 160a, and when the battery voltage VBAT is equal to or less than the reference voltage Vref, the PWM signal generating unit 404b outputs a PWM disable control signal PWM_DB to the backlight driving unit 160a, wherein the PWM disable control signal PWM_DB disables a control using the PWM method.

The shown backlight driving unit 160a includes a current adjustment control unit 602 and a PWM control unit 604. When the backlight driving unit 160a receives the PWM signal from the PWM signal generating unit 404b, the PWM control unit 604 generates the backlight driving signal BLC by using the PWM signal. When the backlight driving unit 160a receives the PWM disable control signal PWM_DB from the PWM signal generating unit 404b, the current adjustment control unit 602 directly controls an amplitude of a current of the backlight driving signal BLC. The current adjustment control unit 602 may control the amplitude of the current of the backlight driving signal BLC by using a signal of a serial driving method.

In addition, FIG. 6 illustrates an exemplary structure of the battery voltage detecting unit 406. As illustrated in FIG. 6, the battery voltage detecting unit 406 may be formed as a transistor that outputs an active level when the battery voltage VBAT is larger than the reference voltage Vref, and that outputs an inactive level when the battery voltage VBAT is equal to or less than the reference voltage Vref.

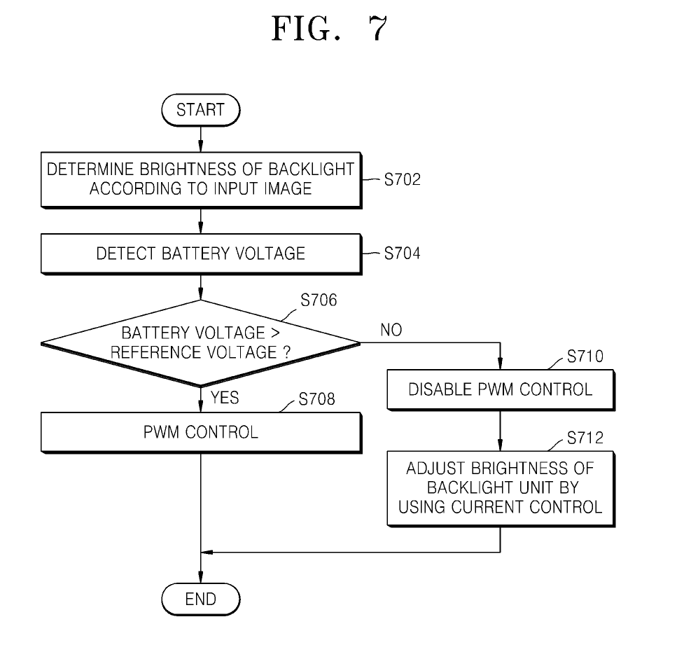

FIG. 7 is a flowchart of a method of driving an LCD, according to another embodiment of the present invention.

The brightness of the backlight unit 150 is determined according to an input image (operation S702). The battery voltage VBAT is detected (operation S704), and the battery voltage VBAT is compared with the reference voltage Vref (operation S706). When the battery voltage VBAT is larger than the reference voltage Vref, a PWM control is performed (operation S708). When the battery voltage VBAT is less than the reference voltage Vref, the PWM control is disabled (operation S710), and an amplitude of a current of the backlight driving signal BLC is directly controlled so that the brightness of the backlight unit 150 is adjusted (operation S712).

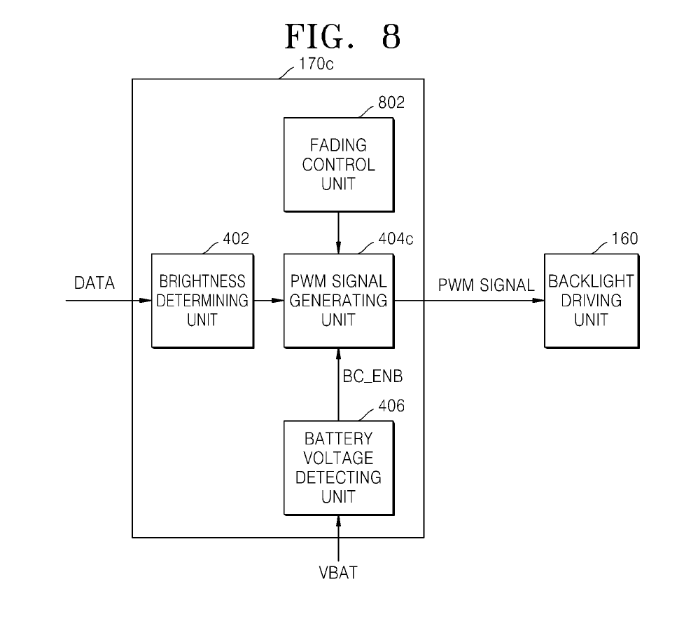

FIG. 8 is a diagram of a structure of a brightness adjusting unit 170c and the backlight driving unit 160 according to another embodiment of the present invention. According to the shown embodiment, a PWM signal generating unit 404c controls a PWM control in conjunction with a battery voltage VBAT, only when brightness of the backlight unit 150 is adjusted by performing a fading operation, when the brightness of the backlight unit 150 is adjusted by a control of the brightness determining unit 402, or when a brightness level of the backlight unit 150 is changed. When screen flicker causes a problem in adjusting the brightness of the backlight unit 150 by performing a PWM method is when the brightness of the backlight unit 150 is changed due to that the brightness of the backlight unit 150 is adjusted by performing a fading operation or by performing brightness adjustment by the brightness determining unit 402. Thus, when a brightness change event does not occur, the present embodiment involves performing a brightness control of the backlight driving unit 160 according to the PWM method, not in conjunction with the battery voltage VBAT. Only when the brightness change event occurs, the present embodiment involves controlling the PWM control in conjunction with the battery voltage VBAT.

The brightness adjusting unit 170c includes the brightness determining unit 402, the PWM signal generating unit 404c, a battery voltage detecting unit 406, and a fading control unit 802.

When the brightness of the backlight unit 150 is adjusted by performing the PWM method according to a fading method, the fading control unit 802 controls the PWM signal generating unit 404c to generate a PWM signal according to the fading method. The fading control unit 802 may control brightness adjustment events other than a brightness adjustment event performed by the brightness determining unit 402, and the brightness adjustment events include an event for fading the brightness of the backlight unit 150 by a user input.

When a control signal for fading the brightness of the backlight unit 150 is input from the fading control unit 802, or when a control signal for adjusting the brightness of the backlight unit 150 is input from the brightness determining unit 402, the PWM signal generating unit 404c determines a frequency of the PWM signal according to the battery voltage VBAT, or turns on/off a control using the PWM method. For example, in a case where an event occurs so as to change the brightness of the backlight unit 150 by the fading control unit 802 or the brightness determining unit 402, the PWM signal generating unit 404c may set the frequency of the PWM signal as a first frequency when the battery voltage VBAT is larger than the reference voltage Vref, and the PWM signal generating unit 404c may set the frequency of the PWM signal as a second frequency that is less than the first frequency when the battery voltage VBAT is equal to or less than the reference voltage Vref. In another case where the event occurs so as to change the brightness of the backlight unit 150 by the fading control unit 802 or the brightness determining unit 402, the PWM signal generating unit 404c may perform a PWM control when the battery voltage VBAT is larger than the reference voltage Vref, and the PWM signal generating unit 404c may disable the PWM control when the battery voltage VBAT is equal to or less than the reference voltage Vref.

In the shown embodiment, the PWM signal generating unit 404c may be configured in such a manner that the PWM signal generating unit 404c controls the PWM control in conjunction with the battery voltage VBAT only when a fading operation is performed by a control of the fading control unit 802. The PWM signal generating unit 404c does not perform the PWM control in conjunction with the battery voltage VBAT when the brightness of the backlight unit 150 is changed by the brightness determining unit 402.

Further, according to the present embodiment, when the battery voltage VBAT is equal to or less than the reference voltage Vref, the brightness determining unit 402 may disable brightness adjustment according to an input image, which is performed by the brightness determining unit 402. This is because, since brightness of the LCD 100 is low when the battery voltage VBAT is low, an effect of the brightness adjustment is small even when the brightness of the backlight unit 150 is adjusted according to the input image.

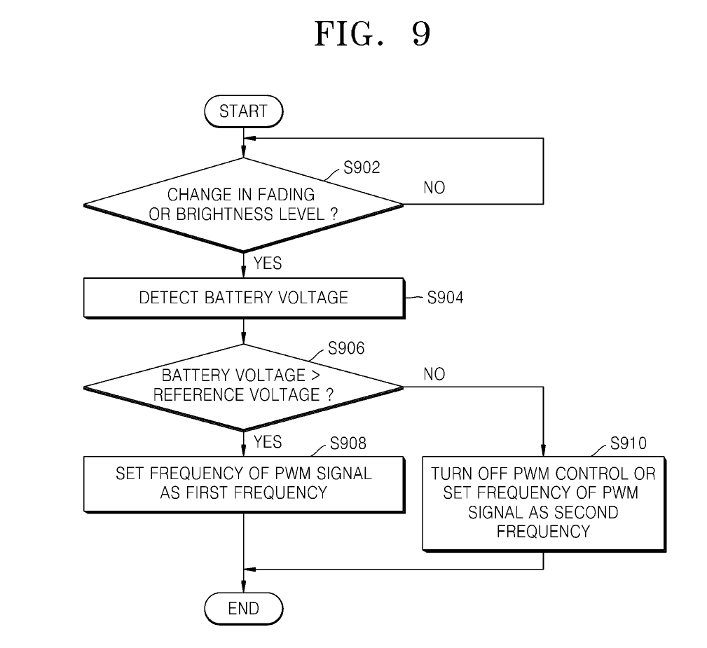

FIG. 9 is a flowchart of a method of driving an LCD, according to another embodiment of the present invention. The method involves determining whether a fading event by the fading control unit 802, or a brightness adjustment event by the brightness determining unit 402 occurs (operation S902). In a case where the fading event or the brightness adjustment event occurs (operation S902), the method involves detecting the battery voltage VBAT (operation S904), and determining whether the battery voltage VBAT is larger than the reference voltage Vref (operation S906). If the battery voltage VBAT is larger than the reference voltage Vref, a frequency of a PWM signal is set as a first frequency (operation S908). If the battery voltage VBAT is equal to or less than the reference voltage Vref, a PWM control is stopped or the frequency of the PWM signal is set as a second frequency that is less than the first frequency (operation S910). If no fading event or brightness adjustment event is occurring (operation S902), the determining is performed again without checking the battery voltage.

While not required in all aspects, aspects of the invention such as the PWM signal generating unit can be implemented using software and/or firmware encoded on at least one computer readable medium implementing one of more of the operations and executed by one or more general and/or special purpose processors.

According to the embodiments of the present invention, by controlling adjustment of the brightness of the backlight unit according to the PWM method in conjunction with the battery voltage, it is possible to prevent the occurrence of the stripe noise and simultaneously to prevent the screen flicker.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of driving a liquid crystal display (LCD) that operates by receiving power from a battery, the method comprising:
generating a pulse width modulation (PWM) signal for adjusting a brightness of a backlight unit;
detecting a battery voltage; and
adjusting the PWM signal to be generated according to the detected battery voltage.

2. The method of claim 1, wherein:
the adjusting of the PWM signal comprises:
comparing the detected battery voltage with a reference voltage;
setting a frequency of the PWM signal to be generated as a first frequency when the detected battery voltage is larger than the reference voltage; and
setting the frequency of the PWM signal to be generated as a second frequency when the detected battery voltage is equal to or less than the reference voltage, and
the first frequency is higher than the second frequency.

3. The method of claim 1, wherein the adjusting of the PWM signal comprises:
comparing the detected battery voltage with a reference voltage;
setting a frequency of the PWM signal to be generated as a first frequency when the detected battery voltage is larger than the reference voltage; and
disabling the PWM signal so as to disable the adjusting of the brightness of the backlight unit by the PWM signal, when the detected battery voltage is equal to or less than the reference voltage.

4. The method of claim 3, further comprising, when the detected battery voltage is equal to or less than the reference voltage, controlling the brightness of the backlight unit by directly controlling an amplitude of a driving current that is supplied to the backlight unit.

5. The method of claim 2, wherein the first frequency is a frequency for preventing a stripe noise from occurring on a display screen of the LCD.

6. The method of claim 2, wherein the second frequency is a frequency for preventing screen flicker from occurring on the LCD when the brightness of the backlight unit is adjusted by performing a fading method.

7. The method of claim 1, further comprising:
adjusting the brightness of the backlight unit according to an input image of the LCD; and
disabling the adjusting of the brightness of the backlight unit according to the input image, when the detected battery voltage is equal to or less than a reference voltage.

8. The method of claim 1, further comprising determining whether the adjusting of the brightness of the backlight unit is performed by using a fading method,
wherein the detecting of the battery voltage and the adjusting of the PWM signal are performed only when the adjusting of the brightness of the backlight unit is performed by using the fading method.

9. The method of claim 1, further comprising determining whether an event for changing the brightness of the backlight unit occurs,
wherein the detecting of the battery voltage and the adjusting of the PWM signal are performed only when the event for changing the brightness of the backlight unit occurs.

10. The method of claim 1, wherein the backlight unit comprises a light emitting diode (LED).

11. An apparatus for driving a liquid crystal display (LCD) that operates by receiving power from a battery and includes a backlight unit, the apparatus comprising:
a battery voltage detecting unit for detecting a battery voltage of the battery; and
a pulse width modulation (PWM) signal generating unit for generating a PWM signal so as to control a brightness of the backlight unit, and for adjusting the PWM signal being generated according to the detected battery voltage.

12. The apparatus of claim 11, wherein:
the battery voltage detecting unit compares the battery voltage with a reference voltage, and outputs a battery voltage detection signal to the PWM signal generating unit,
the battery voltage detection signal indicates a result of the comparison;
the PWM signal generating unit sets a frequency of the PWM signal as a first frequency when the battery voltage detection signal indicates the battery voltage is larger than the reference voltage, and sets the frequency of the PWM signal as a second frequency when the battery voltage detection signal indicates the battery voltage is equal to or less than the reference voltage; and
the first frequency is higher than the second frequency.

13. The apparatus of claim 11, wherein:
the battery voltage detecting unit compares the battery voltage with a reference voltage, and outputs a battery voltage detection signal to the PWM signal generating unit,
the battery voltage detection signal indicates a result of the comparison; and
when the battery voltage detection signal indicates the battery voltage is larger than the reference voltage, the PWM signal generating unit sets a frequency of the PWM signal as a first frequency, and when the battery voltage detection signal indicates the battery voltage is equal to or less than the reference voltage, the PWM signal generating unit disables the PWM signal so as to disable adjustment of the brightness of the backlight unit by the PWM signal.

14. The apparatus of claim 13, wherein, when the battery voltage detection signal indicates the battery voltage is equal to or less than the reference voltage, the PWM signal generating unit generates a PWM disable control signal for controlling the brightness of the backlight unit by directly controlling an amplitude of a driving current that is supplied to the backlight unit.

15. The apparatus of claim 14, further comprising a backlight driving unit for generating a backlight driving signal, outputting the backlight driving signal to the backlight unit, and adjusting the brightness of the backlight unit by adjusting an amplitude of a current of the backlight driving signal,
wherein:
the PWM signal generating unit outputs the PWM signal to the backlight driving unit, and
the backlight driving unit comprises:
a PWM control unit for generating the backlight driving signal according to the PWM signal, outputting the backlight driving signal to the backlight unit, and operating only when the PWM disable control signal is disabled; and
a current adjustment control unit for generating the backlight driving signal by directly controlling the amplitude of the current of the backlight driving signal so as to adjust the brightness of the backlight unit, and operating only when the PWM disable control signal is enabled.

16. The apparatus of claim 12, wherein the first frequency is a frequency for preventing a stripe noise from occurring on a display screen of the LCD.

17. The apparatus of claim 12, wherein the second frequency is a frequency for preventing screen flicker from occurring on the LCD when the brightness of the backlight unit is adjusted by performing a fading method.

18. The apparatus of claim 11, further comprising a brightness determining unit for adjusting the brightness of the backlight unit according to an input image of the LCD, and
wherein, when the battery voltage is less than the reference voltage, the brightness determining unit disables adjustment of the brightness of the backlight unit according to the input image.

19. The apparatus of claim 11, further comprising a fading control unit for controlling the brightness of the backlight unit to be adjusted by using a fading method, and
wherein the PWM signal generating unit adjusts the PWM signal according to the battery voltage only when the adjustment of the brightness of the backlight unit is performed by using the fading method.

20. The apparatus of claim 11, wherein the PWM signal generating unit adjusts the PWM signal according to the battery voltage only when an event for changing the brightness of the backlight unit occurs.

21. The apparatus of claim 11, wherein the backlight unit is implemented by using a light emitting diode (LED).

22. A liquid crystal display (LCD) comprising:
a plurality of pixels positioned at crossing points of data lines and gate lines;
a gate driving unit for outputting a scan pulse to each of the plurality of pixels via the gate lines;
a data driving unit for generating a data voltage corresponding to an input image, and then outputting the data voltage to each of the plurality of pixels via the data lines;
a backlight unit for emitting light to the plurality of pixels;
a backlight driving unit for controlling an operation of the backlight unit; and
a brightness adjusting unit for outputting a pulse width modulation (PWM) signal to the backlight driving unit, the brightness adjusting unit comprising:
a battery voltage detecting unit for detecting a battery voltage from a battery supplying power to the LCD; and
a PWM signal generating unit for generating a PWM signal so as to control a brightness of the backlight unit, and for adjusting the PWM signal according to the detected battery voltage.

23. The method of claim 3, wherein the first frequency is a frequency for preventing a stripe noise from occurring on a display screen of the LCD.

24. A method of driving a liquid crystal display (LCD) that operates by receiving power from a power source, the method comprising:
selecting a pulse width modulation (PWM) signal for adjusting a brightness of a backlight unit of the LCD according to a detected voltage provided by the power source of the LCD; and
generating the selected PWM signal.

25. The method of claim 24, wherein the selecting the PWM signal comprises selecting between PWM signals having different frequencies according to the detected voltage.

26. The method of claim 24, wherein the selecting the PWM signal comprises:
selecting a frequency of the PWM signal as a first frequency when the detected voltage is larger than a reference voltage; and
selecting the frequency of the PWM signal as a second frequency other than the first signal when the detected voltage is not larger than the reference voltage, the first frequency being higher than the second frequency.

27. The method of claim 24, wherein the selecting the PWM signal comprises:
setting a frequency of the PWM signal as a first frequency when the detected voltage is larger than a reference voltage; and
disabling the PWM signal so as to disable the adjusting of the brightness of the backlight unit by the PWM signal, when the detected voltage is not larger than the reference voltage.

28. The method of claim 27, when the detected voltage is not larger than the reference voltage, further comprising controlling the brightness of the backlight unit by directly controlling an amplitude of a driving current that is supplied to the backlight unit.

29. The method of claim 24, further comprising:
adjusting the brightness of the backlight unit according to an input image of the LCD; and
disabling the adjusting of the brightness of the backlight unit according to the input image, when the detected voltage is not larger than a reference voltage.

30. The method of claim 24, further comprising determining whether the adjusting of the brightness of the backlight unit is performed by using a fading method,
wherein the selecting the PWM signal is performed when the adjusting of the brightness of the backlight unit is performed by using the fading method, and the selecting the PWM signal is not performed when the adjusting of the brightness of the backlight unit is not performed by using the fading method.

31. The method of claim 24, further comprising determining whether an event for changing the brightness of the backlight unit occurs,
wherein the selecting the PWM signal is performed when the event for changing the brightness of the backlight unit occurs, and the selecting the PWM signal is not performed when the event for changing the brightness of the backlight unit does not occur.

32. A computer readable medium encoded with processing instructions for implementing the method of claim 24 executed by one or more processors.
